(19) United States
(12) Patent Application Publication
(10) Pub. No.: US 2005/0080693 A1
(43) Pub. Date: Apr. 14, 2005

(54) Point-of-sale customer identification system

(76) Inventors: Sheldon H. Foss JR., Suwanee, GA (US); Dennis H. James JR., Atlanta, GA (US)

Correspondence Address: LAVA Group Law by Smith & Frohwein, P.O. Box 88148, Atlanta, GA, 30356, US

(21) Appl. No.: 10/829,056

(22) Filed: Apr. 21, 2004

Related U.S. Application Data
(63) Continuation-in-part of application No. 10/685,277, filed on Oct. 14, 2003.

(51) Int. Cl. G06F 17/60

(52) U.S. Cl. 705/30; 705/39; 705/16

(57) ABSTRACT

Point-of-sale customer identification is provided. One embodiment is a merchant teminal comprising: a scanner for scanning a personal identification document corresponding to a customer requesting a point-of-sale transaction; and logic configured to identify customer data from a scanned image of the personal identification document. Another embodiment is a method implemented by a merchant terminal comprising: scanning a personal identification document corresponding to a customer; and generating customer data from a scanned image of the personal identification document.

### CROSS-REFERENCE TO RELATED APPLICATIONS

This application is a continuation-in-part application of copending U.S. patent application Ser. No. 10/685,277, entitled “System, Method and Apparatus for Providing Financial Services,” filed on Oct. 14, 2003, which is related to U.S. patent application Ser. No. 10/645,949, entitled “System for Providing a Checkless Checking Account,” filed on Aug. 22, 2003 and U.S. patent application Ser. No. 10/646,150, entitled “System and Method for Dynamically Managing a Financial Account,” filed on Aug. 22, 2003, all of which are incorporated by reference in their entirety.

### BACKGROUND

Throughout the years, a main focus of providing services to consumers has been convenience. It is quite clear to even the most simplistic marketing analyst that the more convenient you can make a service to the consumer, the more likely the consumer will partake in the service. It is on this foundation that the majority of Internet services are based.

The Internet is not always the final answer in providing convenience to the consumer. In some instances, consumers are simply reluctant to conduct business over the Internet due to a variety of reasons, such as fear of losing confidentiality, resistance to relying on modern technology and sometimes, just stubbornness. Thus, there has been, is and remains a need in the art for providing face to face, plain old ordinary customer service.

The banking and credit industry is particularly poised in this predicament. Consumers that are engaging in financial transactions or receiving financial services often times prefer to deal with an institution rather than the Internet. Thus, marketers are still challenged with increasing the convenience at which such services are offered.

One avenue that has been extensively explored for providing financial services is through merchants. Consumers typically are willing to trust a merchant that is offering a financial service. This is evident in the fact that nearly every department store offers a credit program to their customers.

Typically, merchants are limited to the types of financial services that they can provide. This limitation can be due to a variety of factors including the cost that the merchant must incur to provide the service, the technological complexities of providing the service, and the training required for the merchant's employees. However, anyone that has completed a marketing 101 class will agree that the more services a merchant can offer, the more foot traffic the merchant will generate and, thus, the higher probability the merchant will get a sale.

Thus, there is a need in the art for a solution that enables a merchant to provide multiple financial services to its customers, that is commercially feasible to the merchant, not overly complicated from a technological perspective, and that minimizes the training required for the merchant's employees.

### SUMMARY

The present invention is a unique and novel solution to these needs in the art and includes a system, method and apparatus for providing a multi-functional terminal that can provide a plurality of financial services to a customer.

The present invention includes a multi-functional terminal that allows a merchant to provide a plurality of financial services to a customer. The multi-functional terminal is operable to accept, read and process a variety of items including, but not limited to, debit/credit or ATM cards, checks, money orders, cashiers checks, travelers checks, as well as driver's licenses, state identification cards, and birth certificates. In addition, the multi-functional terminal can accept a variety of types of information that may be input, such as but not limited to, an individual's direct deposit account (DDA) number, savings account number, etc. The multi-functional terminal also operates to facilitate a purchase, transfer of funds, wire of funds, cash-back option, etc. at a merchant location. The multi-functional terminal advantageously can be used at a merchant location to allow an individual to purchase pre-paid credit-type cards, pre-paid telecom cards, stamps, etc. at the terminal.

In operation, the multi-functional terminal of the present invention comprises a data interface, a processor and a network interface. The data interface interfaces to a plurality of data sources to extract data needed for a particular financial service. The network interface interfaces to a plurality of networks, servers or an individual network or server to obtain verification or authorization information utilized in providing a particular financial service. The processor will control the data flow from the data interface to the network interface, analyze the data and determine the data required for any particular financial service, create account information if necessary, verify data and enable and perform financial services, update the data after completing a financial service if necessary, and any other financial service related processing.

The data interface component operates to obtain the data necessary to perform the financial service selected by the individual. Several techniques can be employed to obtain the data and although there are preferred techniques described herein, the present invention should not be limited to any particular technique. Advantageously, the present invention has the capability of collecting an initial deposit of funds from an individual at the same time as the data is collected in the case of the purchase of a pre-paid credit-type card or phone card. The data collected can include, but is not limited to, information such as the customer's name, date of birth, contact information, government identification such as a Social Security Number, financial status, marital status, employment history, references, or the like. In addition, some level of prior behavior such as the customer's insufficient funds history may be included. The system may also run a credit check on new or renewing customers.

Another aspect of the invention is the collection of the data. The collection may be performed by a number of different methods including, but not limited to, a magnetic type device, a bar code reader, a scanner, a templated scanner, a keyboard, a touch-screen, a microphone, a bio-metric reader, etc. Basically, any item that may contain individual information can be collected by the data interface. The data interface is universal so that any data source may be utilized to supply data.

Another aspect of the invention is the data processing. The processor may require specific data for any particular financial transaction. Once the financial service is established the processor analyzes the data to determine if the appropriate data is present. If additional data is required, the processor will notify the individual or merchant. The processor can analyze and sort the data to extract the required information. In addition, the processor may analyze the data source to determine what data is present on the source and additionally, the location of the data on the data source. For example, in one technique, when a templated scanner is utilized to collect data, the processor will first determine the type of data source (e.g., a driver's license, social security card, etc.). Then, the processor will associate a template with the particular type of data source to extract the necessary data from that source to perform the selected financial service. Then, the pertinent data will be utilized in the particular financial service. Several techniques can be employed to obtain the data and although there are preferred techniques described herein, the present invention should not be limited to any particular technique.

### BRIEF DESCRIPTION OF THE DRAWINGS

Other aspects, advantages and novel features of the invention will become more apparent from the following detailed description of exemplary embodiments of the invention when considered in conjunction with the following drawings.

FIG. 1 is a diagram illustrating an exemplary embodiment of a terminal that facilitates the provision of a variety of financial services.

FIG. 2 is a flow diagram illustrating an overview of the steps and components that can be utilized in conjunction with implementing various embodiments of the present invention.

FIG. 3 is a flow diagram illustrating the processes involved in providing the exemplary financial service of issuing a cash card to a customer through the use of the multi-functional terminal of the present invention.

FIG. 4 is a flow diagram illustrating the operation of an exemplary embodiment of the present invention.

FIG. 5 is a block diagram of another embodiment of a merchant terminal for performing a point-of-sale transaction.

FIG. 6 is a flow chart illustrating the general architecture, operation, and/or functionality of an embodiment of the point-of-sale customer identification system of FIG. 5.

FIG. 7 is a block diagram illustrating an example of a personal identification document and corresponding template for use in the point-of-sale customer identification system of FIGS. 5 & 6.

FIG. 8 is a block diagram of another embodiment of a merchant terminal for performing a point-of-sale transaction.

FIG. 9 is a flow chart illustrating the general architecture, operation, and/or functionality of an embodiment of the point-of-sale customer identification system of FIG. 8.

FIG. 10 is a flow chart illustrating the operation of the merchant terminal of FIG. 8.

FIG. 11 is a flow chart illustrating the general architecture, operation, and/or functionality of an embodiment of the validation module of FIG. 8.

FIG. 12 is a screen shot of an exemplary user interface screen supported by the point-of-sale customer identification system of FIG. 8.

### DETAILED DESCRIPTION

In general, the present invention can be described as a novel system, method and apparatus for a merchant to conveniently provide a variety of financial services to a consumer. The exemplary embodiments described below are for illustrative purposes only and, a person skilled in the art will construe them broadly. It should be understood that the features and aspects of the present invention can be ported into a variety of systems and system/network configurations and any examples provided within this description are for illustrative purposes only. Referring now to the figures, in which like numerals refer to like elements throughout the several views, exemplary embodiments of the present invention are described.

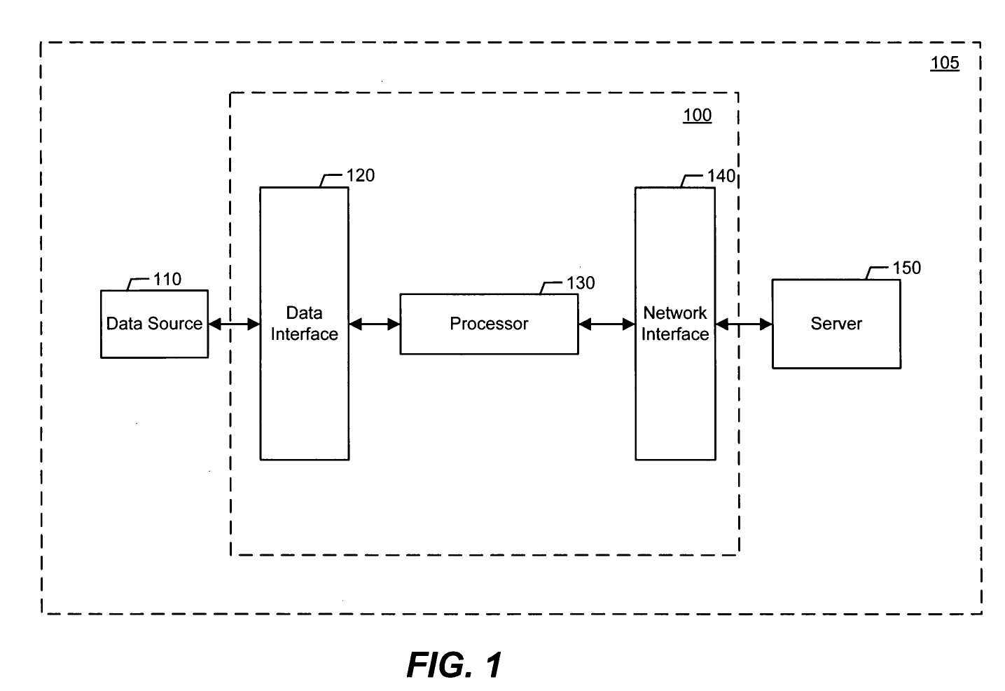

FIG. 1 is a diagram illustrating an exemplary embodiment of a terminal 100 that facilitates the provision of a variety of financial services. The terminal 100 is comprised of a processor 130, a data interface 120 and a network interface 140.

The data interface 120 is coupled both to the processor 130 and can interface to a data source 110. One function of the data interface 120 is to extract session data from the data source 110 and transfer the session data to the processor 130. Another function of the data interface 120 is transferring modified session data from the processor 130 to the data source 110. Thus, in some embodiments, the data interface 120 can transfer data bi-directionally. The data interface 120 may be any type of interface capable of extracting and/or writing to a data source 110. The data interface 120 may incorporate the hardware necessary to read/write to the data source 110 or may simply be an interface to a hardware device such as a bar code reader/writer, a magnetic reader/writer, a scanner, a templated scanner, a printer, a bio-metric identification device, a pass-through inlet/outlet, etc. Further, the data source 110 may consist of many different types of sources, including, but not limited to, a bar code, a magnetic-type card or magnetic storage device, scannable media, writable media, a fingerprint, a keyboard or keypad, a mouse, a light-pen, a touch pad, a display, or any other type of data device. The session data is data that may be utilized in a particular financial service transaction. The session data may be located on the data source 110, or alternatively, may be inputted manually. The session data may include, but is not limited to, name, date of birth, address, telephone number, social security number, verified government identification, direct deposit account (DDA) information and number, savings account information and number, credit history, debt to credit ratio, asset information, a type of financial service, a transaction amount, card account number, etc.

The network interface 140 is coupled to the processor 130 and interfaces to a server 150. One function of the network interface 140 is to provide session data to the server 150. Another function of the network interface 140 is obtaining validation from the server 150 and providing it to the processor 130. The server 150 validates all or a portion of the session data for a variety of different purposes depending on the particular financial service involved. The validation may include, but is not limited to, an approval for a financial service, a denial for a financial service, an available balance or fund verification, a credit worthiness verification, a billing address verification, etc.

The processor 130 is coupled to both the data interface 120 and the network interface 140. One function of the processor 130 is processing the session data and executing or initiating the provision of a plurality of financial services. The processor 130 receives the session data from the data interface 120 and requests a validation from the server 150, based at least in part on the session data, through the network interface 140. Further, the processor 130 provides or initiates the provision of a plurality of financial services and in some embodiments, is capable of updating the session data stored on the data source 110 based at least in part on the provision of the particular financial service. The plurality of financial services may include, but are not limited to, purchasing pre-paid cards, pre-paid card acceptance, credit card acceptance, debit card acceptance, check acceptance, point of sale purchase, cash back on point of sale purchase, transfers, card-to-card activity, bill payment, loyalty acceptance, etc.

FIG. 1 also illustrates the multi-functional terminal 100 within a system for providing financial services 105. The system 105 includes: the terminal 100, a server 150 and one or more data sources 110. In operation, the multi-functional terminal 100 is provided to a merchant for use in store operation. The terminal 100 is interfaced to and granted access to the server 150. The interface to the server 150 can be provided in a variety of fashions including, but not limited to, DSL, T1, broadband, wireless, telephonic and satellite connectivity. The multi-functional terminal 100 is available to merchant employees in providing the financial services to customers. Depending on the desired financial service, a customer obtains and/or presents a data source 110 to the merchant in conjunction with selecting a financial service to be provided.

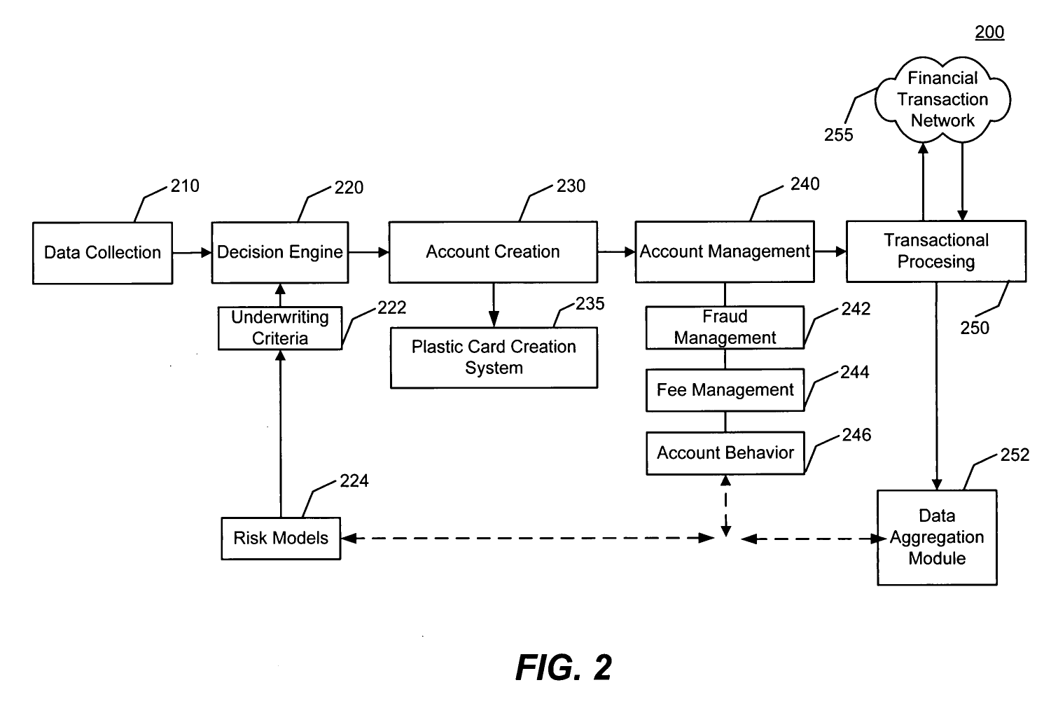

FIG. 2 is a flow diagram 200 illustrating an exemplary embodiment of the present invention. The details of the operation of the flow diagram 200 may vary among various embodiments of the present invention. In general, the illustrated embodiment includes five main functions or components: the data collection component 210, the decision engine 220, the account creation component 230, the account management component 240 and the transactional processing component 250. It should be understood that the structure illustrated in this figure is for discussion purposes only and the various functions or components of the present system could be combined or split in many manners.

The data collection component 210 collects data or information relevant to: opening a credit account (e.g., account formation data), determining if an applicant can qualify for an account, the type of account to be opened (e.g., account option data), and other miscellaneous data. The information collected with regards to the account formation data may include, but is not limited to, the applicant's name, date of birth, mailing, residential and business addresses, telephone numbers, social security number or verified government identification number, direct deposit account (DDA) information and account number, savings account information and account number, credit history, debt to credit ratio, assets, marital status, employment history, etc.

Further information regarding the account formation data, the account option data and the account types (as well as other types of data) can be found in the related applications identified above and which have been incorporated by reference into this specification. After the data collection component 210 receives the necessary or the minimum amount of information, the decision engine 220 can be begin processing.

The decision engine 220 receives raw or processed data from the data collection component 210 and, among other functions, integrates it with underwriting criteria 222 to determine if a customer qualifies for an account. The underwriting criteria 222 is initially determined using a collection of integrated algorithms, methods of work, business processes, and initial risk modules 224 that enable the analysis, issuance, distribution, and monitoring of an integrated credit product. The initial risk models 224 are compiled from a variety of different sources that vary by issuer. One skilled in the art is familiar with the type of information that is associated with them. In addition to determining if a customer qualifies for an account, the decision engine system 220 also determines if a customer qualifies for any applicable account option data selected in the data collection system 210. For example, if a customer selected an overdraft option in the account option data, the decision engine 220 would determine if the customer qualified for that option and, if qualified, the amount of the overdraft limit. The decision engine 220 uses the account formation data to qualify the customer and perform a risk management processes. The customer is subjected to underwriting criteria 222 to determine qualification and some additional data or documents may be required for the process.

Once a customer is qualified, the account creation component 230 proceeds to open an account. The account creation component 230 may perform different functions depending upon the account option data. Preferably, the account creation component 230 operates to create an account for the customer in a manner that is in compliance with all applicable local, state and federal laws. During the account creation, the account creation component 230 may utilize various procedures to support issuer risk mitigation requirements. The account creation component 230 also includes a plastic card creation component 235 that operates to generate a permanent card for the customer.

The procedures performed by the account creation component 230 may vary depending on the type of account being created. In the examples provided in the incorporated references identified above, the three account types include the instant issue card, the basic card and the basic card with overdraft protection. Other functions that may be performed by the account creation component 230 include the activation of the account the issuance of cards. The details of these functions are more specifically described in the incorporated references.

The account management component 240 manages the customer account by utilizing controllers to enable and disable certain functions and privileges of the account based on various factors. Some of the factors can include account risks and customer behaviors. In one embodiment, the account management component 240 can include the functions of fraud management model 242, fee management model 244 and account behavior model 246. The fraud management model 242 can utilize the operation of the account behavior model 246 to determine if any fraudulent activities are associated with the account. If any fraudulent activities are detected, the account management component 240 can be notified by the fraud management model 242 to suspend the account. The fee management model 244 determines and assesses any applicable fees to be charged against the account. For example, if the account is overdue, a late fee would be assessed to the account. In the various embodiments, additional fees can be assessed against the accounts. For instance, a one time fee may be assessed for the creation of the account or for the creation of certain accounts, such as accounts having an overdraft component 234. In addition, the account may include a fixed number of transactions or a fixed number of transactions per fixed period (e.g., per month). Once the fixed number of transactions is exceeded, additional transactions can be assessed a transaction fee. In another embodiment, a monthly fee may be assessed on the account.

The account behavior model 246 examines account activity and looks for patterns in the account activity to determine possible actions to be taken (e.g., intervention to stop fraud). For example, if an account appeared to have sporadic spending or if the stored value became zero, the account could be turned off temporarily to ascertain if the account is being defrauded. The transactional processing component 250 processes and monitors the day to day transactions between the account and the financial transaction network 255. The transactional processing component 250 is then compiled by the data aggregation module 252.

The data aggregation module 252 may work on data related to the entire population of account holders, groups of populations based on factors such as age, occupation, areas of domicile etc. or even individuals. The data aggregation module 252 provides processed outputs to the risk models 224 and the account behavior 246 model.

A key aspect of the present invention is found in the operation of the account management component 240. The account management component 240 of the present invention enables the dynamic management and alteration of the financial account based on real-time and current information. Two controlling factors are applied to the account management component 240. These controlling factors include the output of risk models 242 that have been run on the initial underwriting criteria collected by the data collection component 210, as well as the output of the data aggregation module 252.

The data aggregation module 252 refines and updates, preferably on a real-time basis, the various current trends of the accounts being managed. This information is then fed into the risk models 224 which determine new underwriting criteria 222, and the account behavior 246 model. The data aggregation module 252 can feed information into the risk models 224 and the account behavior 246 model at periodic intervals, continuously, autonomously, on request, or on other bases. The account behavior model 246 can operate to alter the parameters of the operation of the credit account. The account behavior model 246 can base these alterations on the input from the aggregation module 252 and/or the risk models 224. Thus, in operation, the data aggregation module 252 may identify trends for a particular subset of the population. This information in turn can be used by the risk models 224 to identify certain risks associated with the particular subset or related subsets of the population. This information, as well as the information directly provided from the data aggregation module 252 can serve as the basis for altering the parameters of the credit account. As a particular example, suppose that the data aggregation module 252 identifies an increase in transactions by customers identified as working in the airline sector and the risk models 224 indicate a decline in job stability in the transportation industry. The account behavior model 246 may utilize this information to decrease the lines of credit provided to customers working in the airline sector, increase fees associated with their accounts, provide a higher level of scrutiny on approvals of purchases, lock the account from further purchases, or the like. From a fraud perspective, the account behavior model can receive information from the data aggregation module 252 that may be an indication of fraudulent behavior. The account behavior module 246 can then take actions to limit or alleviate the risk of fraud.

Similarly, the risk models 224 can receive input from the data aggregation module 252 and/or the account behavior model 246. The information fed to the risk models 224 is used as the basis for generating new underwriting criteria for qualifying new individuals for accounts. The new underwriting criterion provides more accurate real-time criteria that are not otherwise available when using underwriting criteria that has only been created at the initial stages of qualification.

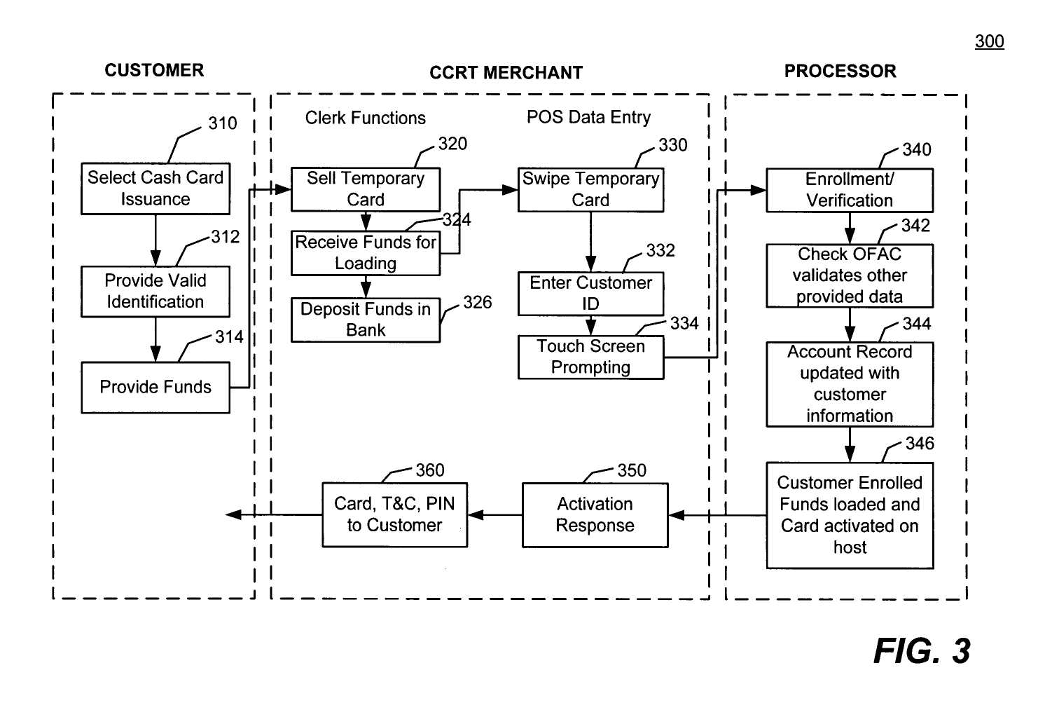

FIG. 3 is a flow diagram illustrating the processes involved in providing the financial service of issuing a cash card to a customer through the use of the multi-function terminal 100 of the present invention 300. Initially a customer approaches a merchant that has a multi-function terminal. The customer selects, or with the help of the merchant, selects the financial option of the issuance of a cash card 310. The customer is then prompted to provide valid identification 312 and funding for the cash card 314.

The merchant's clerk working with the customer initiates the sell of a temporary card 320. The clerk then receives the funding from the customer that will be used for loading value into the cash card 324. Independently the merchant deposits the funds in a banking institution, transfers the funds to an appropriate account or issues a transaction against a credit card 326. In addition, the clerk swipes the temporary card through the terminal 330. The terminal 100 reads the magnetic strip on the back of the temporary card and extracts an identification number for the card. The clerk then enters the identification of the customer 332. The identification can be obtained from the valid identification presented by the customer or through some other means. The clerk then follows one or more steps prompted by the multi-functional terminal. In the illustrated embodiment, this is done through a touch screen on the multi-function terminal 334.

The information collected at this point in the process is passed to a processor that first operates to enroll the customer and verify the information received from the customer 340. The processor then conducts an OFAC check and validates other data provided by the customer 342. An account record is then either created, or updated if this is a repeat customer, with the customer information 344. The processor then operates to enroll the customer, load the provided funds onto a card and activate the card in conjunction with a host or server managing the processor 346.

If the customer is approved, an activation response is provided to the multi-functional terminal 350 and a card, terms and conditions and a PIN is provided to the customer 360. At this point the customer is then able to use the temporary card. In some embodiments, a permanent card will then be created and mailed to the customer.

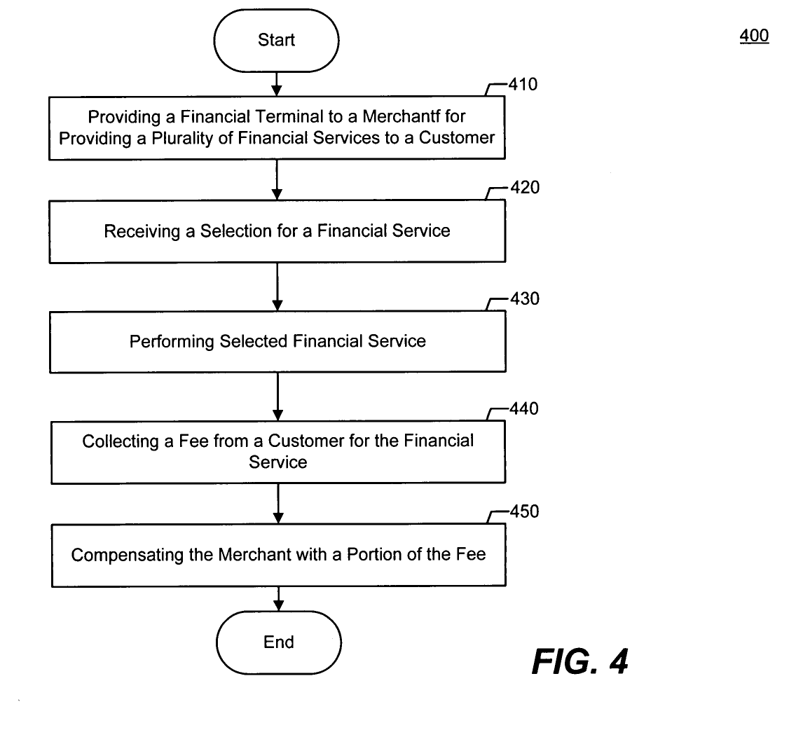

FIG. 4 is a flow diagram illustrating the operation of an exemplary embodiment of the present invention. One aspect of the present invention is providing an entire suite of financial services that are available to a customer, or a customer working with a merchant 400. The first step in providing the suite of financial services 400 is providing a multi-functional terminal to a merchant 410. In conjunction with this, the multi-functional terminal can be integrated into the merchant's communication infrastructure as well as being connected to the server 150 that operates in conjunction with the terminal 100. The multi-functional terminal 100 is operable to provide the suite of financial services to a customer.

Once the multi-functional terminal 100 or terminals are installed and operational at the merchant location, the multi-functional terminal 100 can be access by a customer and/or a merchant to initiate the provision of a financial service selected from the suite of financial services available.

One of the overall purposes of the present invention is to allow customers to have instant access to a suite of financial services at a variety of locations convenient to the customer. Thus, the service provider of the financial services equips multiple merchants with the terminal 100 equipment.

The suite of financial services can be accessed from the multi-functional terminal 100 in a variety of manners. Thus, in an exemplary embodiment, a terminal 100 gives a service provider the ability to identify and process a customer requesting a financial service at a retail merchant point of sale. The terminal 100 operating in conjunction with the server 150 and other resources insures compliance with identification and qualification requirements established by competent authorities and/or the service provider. The merchant makes the terminal 100 available for use by a customer or the merchant operates the terminal 100 on behalf of the customer.

The financial service can include one of several financial services, such as purchasing a stored-value card, transferring of funds, wiring funds, obtaining cash in an ATM fashion, purchasing a pre-paid credit-type card, purchasing a pre-paid telecom card, stamps, etc. at the terminal. One key aspect of the present invention is that a single terminal 100 can provide any and all of these financial services as well as other services.

In one embodiment a menu of services available can be displayed on a screen and selected by a customer and/or merchant. In another embodiment, the customer may swipe a card through the card reader of the terminal 100 and after identifying the customer or card identification, the terminal 100 can indicate the financial services available. In addition, it should be noted that the terminal 100 can operate in conjunction with the server 150 to determine the financial services available to the customer. Regardless of the method of indicating the services available or the method employed for selecting one of the suite of services, the terminal 100 receives a selection for a financial service 420. The selection is made from the plurality of financial services available to the customer.

The selected financial service is performed 430. This process can vary greatly depending on the selected financial service. However, in most situations, the customer is prompted to provide additional information that is entered into the multi-functional terminal 100 in one of the various previous manners disclosed. Once the multi-functional terminal 100 has sufficient information, the multi-function terminal 100 interacts with the server to determine if the financial service can be provided, if the customer qualifies and to verify the information is correct. This process may involve requesting additional information from the customer and/or the merchant. Ultimately, the financial service is provided to the customer.

A fee is collected from the customer for the provision of the financial service 440. As has been described, this fee can be collected in a variety of manners including cash, credit cards, bank transfers or the like.

A key aspect of the present invention is the step of compensating the merchant with a portion of the fee collected from the customer 450. This varies from the current state of the art. Traditionally, merchants have paid a fee to have terminal equipment installed on their premises and/or paid a fee for certain transactions. The system implementation of the present invention utilizes various means for compensating the merchant for housing and operating the equipment at the merchant's location. In one embodiment, the merchant may simply be given a flat fee for each terminal 100. In another embodiment, the merchant may be paid a fee based on the number of terminals 100 and the number of transactions provided using the terminals 100. In yet another embodiment, the merchant may be compensated based solely on the number of transactions. In yet another embodiment, the merchant may be compensated based on a percentage value of the transactions. Those skilled in the art will appreciate that any of these compensation methods, as well as a combination of one or more of these methods may be utilized and the present invention is not limited to any particular configuration.

The Suite of Services: The present invention can be utilized to provide a suite of financial services to a customer at a variety of merchant locations. The general descriptions of these financial services are provided below.

Stored-Value Card: For the financial service of purchasing a stored-value card, the customer purchases a pre-paid or stored-value magnetic-type card (the data source 110), from the merchant. The detailed components for this financial service were described in conjunction with FIG. 3. The overall operation of this financial service enables the merchant to initiate and issue a stored-value card. The merchant can accept payment for the card in a variety of manners including cash, credit card, money transfer, check, etc. The merchant may supply and swipe the card through a magnetic card reader (the data interface 120), interfaced to the terminal 100. This process allows the terminal 100 to capture the account number of the card. The merchant may then enter a value for the card into the terminal 100 through the data interface 120. As previously described, this information can be provided to the terminal 100 in a variety of manners including the use of a keyboard, scanner, magnetic card reader or the like. In one embodiment, the merchant may acquire certain additional information from the customer, such as the customer's name, date of birth, social security number, DDA number, etc.). The merchant may then enter this information into the data interface 120 of terminal 100. Although this aspect of the invention is being described as a customer and merchant performing certain tasks, it should be understood that either of the participants could perform the tasks and some of the tasks could even be automated.

Once the merchant has collected all of the information, or even during the information collection process, all or portions of the information are provided to the server 150 through the network interface 140. The server processes the information in a manner that is familiar to those skilled in the art. The incorporated references provide further information regarding this process. The merchant then waits for the terminal 100 to receive authorization from the server 150.

The funds for the stored-value card can be provided by the customer in a variety of manners. In one embodiment, the stored-value card may be funded directly from the customers direct deposit account (DDA), thus the limit of the pre-paid or stored value card is the amount taken from the account and placed on the card. In another embodiment, the stored-value can be funded based on a credit as authorized by the service provider, thus the limit of the card is limited by the amount of credit authorized. The stored-value card can also be funded by a direct cash transaction at the terminal 100. Thus, the value of the stored-value card can be selected by the customer or merchant and as long as funds are available.

The authorization of the stored-value card can be based on a number of factors, including, but not limited to, credit worthiness, credit history, credit score, balances in customer accounts, etc. Once an authorization has occurred, the card is activated and a stored value or credit limit is associated with the card. In one embodiment, the activation process may include writing information out to the data source 110, in this case the stored-value card. For instance, the value associated with the stored-value card, an expiration date, an authorized user name, PIN code, terminal 100 and/or merchant at which the card was activated, date of activation, or a variety of other information could be stored on the stored-value card. The customer may then make purchases from the merchant using the pre-paid or stored-value card.

In addition, once a financial service is provided, such as using the stored-value card, the terminal 100 can operate to update the session data after performing a financial service and sends the updated data to the data source 110. The customer can then use the terminal 100 to view activity data, history data or other data associated with the data source 110.

The process for issuing a stored-value card is also applicable to the purchasing a pre-paid credit-type card as well as a pre-paid telecom card.

Transferring of Funds: For the financial service of conducting a fund transfer, the customer initiates the transfer by selecting the appropriate feature from the terminal 100. The present invention can be used to transfer funds from one account into another account, from a stored-value card to an account, or from an account to a stored-value card. For transferring funds from one card to another, the customer can simply swipe the card through the card reader of the terminal 100 and select an option to transfer the balance, or a portion thereof to another card. The balance can be transferred to another card held by the customer or to another card not even owned by the customer. In this case, the customer will be required to enter a card identification number, account number and/or customer identification information into the terminal 100. The server 150 operates to receive the fund transfer request. If the transfer is a card to card transfer, the server 150 can communicate with the terminal 100 and instruct the customer to swipe the destination card or enter the necessary information to identify the destination for the transfer. If the transfer is to be made to a card not in the customer's possession, the server 150 can receive and maintain information regarding the transfer. Once the system is accessed by the destination card or a card associated with a customer or account destined to receive the transfer, the server 150 can initiate the completion of the transfer. If the funds are destined for an account, the server 150 can transfer the funds directly into the account once the appropriate information is entered. If the transfer request is to transfer funds from an account onto the card, the process is similar to that described in conjunction with the stored-value card financial service.

Wiring Funds: For the financial service of conducting a wiring fund transfer, the customer initiates the transfer by selecting the appropriate feature from the terminal 100. Similar to the funding options for the stored-value card, the customer can utilize the same options for funding the wiring transfer. The terminal 100 collects the necessary information by prompting the customer for the information. In the alternative, the server 150 can cause the terminal 150 to prompt for specific information. In either case or using a combination of both, the information is collected and transferred to the server. The server then actuates the wire transfer.

Cash-back: For the financial service of providing access to cash, the customer initiates the service by selecting the appropriate feature from the terminal 100. The funds to support cash access can be based on a credit card, money transfer, check, etc. The terminal 100 collects the necessary information by prompting the customer for the information. In the alternative, the server 150 can cause the terminal 150 to prompt for specific information. In either case or using a combination of both, the information is collected and transferred to the server. The server 150 then approves the financial service and gives in indication to the terminal 100. This same approach can be applied in the purchase of stamps.

Check Acceptance: The terminal 100 can also be used to authorize or verify payments by check. The check can be scanned at the terminal 100, and based on the account information, the server 150 can begin to process approval for the payment. The server 150 and or terminal 100 can request additional information from the customer to complete the financial service and the customer can enter that information at the terminal 100.

Bill Payment: The terminal 100 can be utilized by a customer 150 to pay bills. In operation, the customer enters information to identify the recipient of the bill, along with the amount, source of funds for making the payment, and the like. The terminal 100 and/or server 150 may interact with the customer to obtain additional information. The source of funds can be any of a variety of sources, or a combination of one or more sources, including but not limited to, a stored-value card, banking account, cash, check or the like.

Loyalty awards: The present invention also anticipates providing a loyalty awards program. In one embodiment, the merchant charges a fee for the financial service, a portion of which is supplied to the service provider. In another embodiment, the terminal 100 automatically assesses and extracts a fee for a give financial service and apportions the fee appropriately to the merchant and/or the service provider.

In another exemplary embodiment, a terminal 100 interfaces with a templated scanner through the data interface 120. A templated scanner may be utilized where the data source 110 is a non-magnetic or non-bar coded card (e.g., a driver's license, official document, etc.). The templated scanner extracts session data from the data source 110 and transfers the session data to the processor 130. The processor 130 matches the data source 110 to a recognizable format and associates a pre-defined template to the data source 110. The processor 130 then extracts the data within the templated area for use in the authorization process.

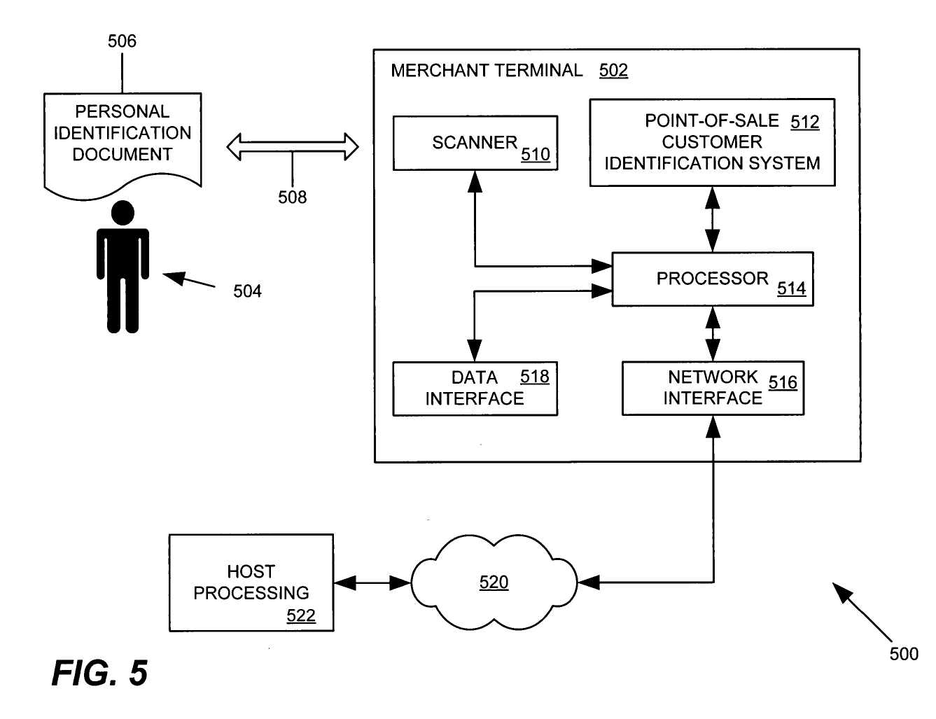

As mentioned above, one of the many methods of collecting data from a customer at a terminal 100 is via a scanner, templated scanner, etc. In this regard, FIG. 5 illustrates one of a number embodiments of a merchant terminal 502 in which data from a customer 504 is collected using a scanner 510. As illustrated in the embodiment of FIG. 5, merchant terminal 502 comprises a scanner 510, a data interface 518, a point-of-sale customer identification system 512, a processor 514, and a network interface 516. In general, processor 514 controls the functional operation of various (although not necessarily all) aspects of scanner 510, data interface 518, point-of-sale customer identification system 512, and network interface 516. Processor 514 and data interface 518 may comprise any of the devices described above with respect to terminal 100 and may be configured in much the same manner. Network interface 516 comprises any device configured to communicate with a remote computer (e.g., issuing host 522) via a communications network 520. Issuing host 522 provides back-end support for processing the various financial services offered by merchant terminal 502.

In addition to receiving customer data (e.g., the session data described above) via data interface 518, scanner 510 enables merchant terminal 502 to scan a personal identification document 506 corresponding to customer 504. Personal identification document 506 may comprise a number of different types of customer-related documents that contain information about customer 504. For example, in certain embodiments, personal identification document 506 may comprise any of the following, or other, types of documents: driver's license, state identification card, social security card, government passport, etc. Furthermore, personal identification document 506 and scanner 510 may mechanically interface (arrow 508—FIG. 5) in a number of ways. In this regard, it should be appreciated that scanner 510 may comprise any device capable of optically interfacing with personal identification document 506. The mechanical configuration of scanner 510 is not relevant. Rather, it should be appreciated that scanner 510 optically scans personal identification document 506 to generate a digital representation (e.g., digital image, etc.) of personal identification document 506.

In general, point-of-sale customer identification system 512 controls the manner in which merchant terminal 502 processes the digital representation of personal identification document 506. Point-of-sale customer identification system 512 may be configured to support any of the operations, financial services, etc. provided by merchant terminal 502. In this regard, it should be appreciated that there are a number of types of situations in which point-of-sale customer identification system 512 may be initiated and used to process the digital representation of personal identification document 506.

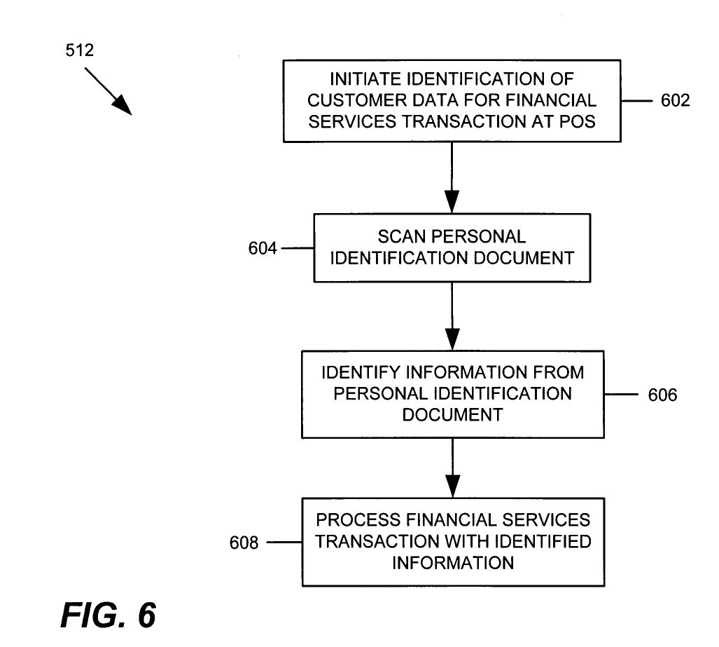

FIG. 6 is a flow chart illustrating the architecture, operation, and/or functionality of an embodiment of point-of-sale customer identification system 512. As illustrated in the embodiment of FIG. 6, point-of-sale customer identification system 512 may be initiated, at block 602, when customer-related data is to be obtained for a particular service being provided by merchant terminal 502 (e.g., a financial services transaction at the point-of-sale). At block 604, a personal identification document 506 of a customer 504 is scanned via scanner 510. Point-of-sale customer identification system 512 may be configured to control, trigger, initiate, etc. the scanning process of personal identification document 506. At block 606, point-of-sale customer identification system 512 identifies information (e.g., customer-related data, etc.) from personal identification document 506. At block 608, point-of-sale customer identification system 512 processes the financial services transaction with the identified information.

It should be appreciated that the particular manner in which the information extracted from personal identification document 506 is used during the financial services transaction may vary depending on the particular service being provided to customer 504. For instance, in one exemplary embodiment, the customer information extracted from personal identification document 506 may be used to verify the identity of customer 504. In this embodiment, the extracted information may be compared to customer information residing at merchant terminal 502, issuing host 522, or any other entity in the system. It should be further appreciated that in other embodiments the information extracted from personal identification document 506 may be combined with data obtained via data interface 518. In further embodiments, merchant terminal 502 may provide a paper-free, point-of-sale transaction by obtaining customer data from personal identification document(s) 506 (via scanner 510) and any other information via data interface 518.

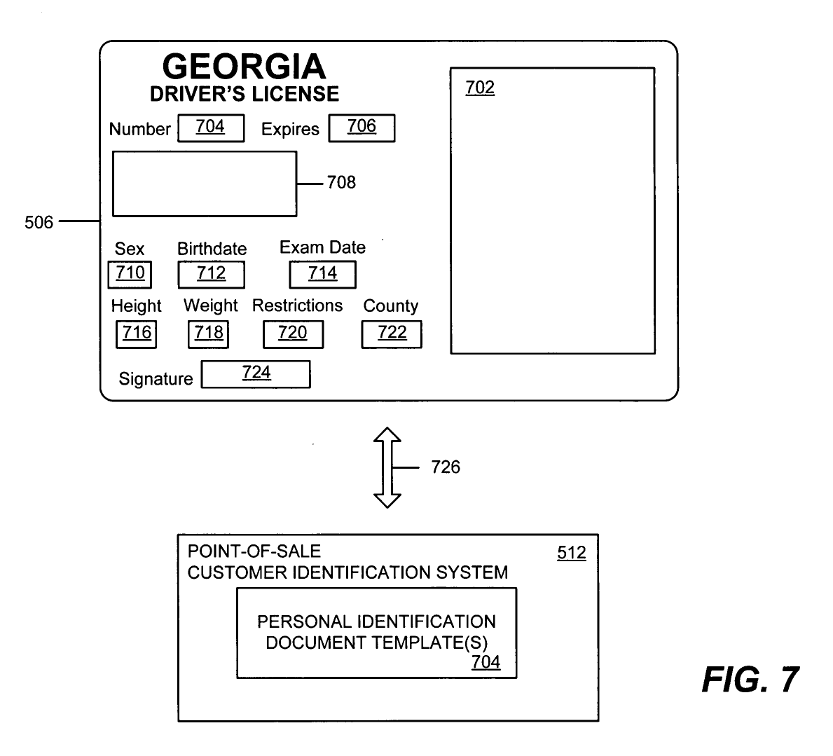

As mentioned above, merchant terminal 502 supports a number of different types of personal identification documents 506. In certain embodiments, point-of-sale customer identification system 512 comprises one or more templates corresponding to type(s) of documents to be scanned. FIG. 7 illustrates an example of one type of personal identification document 506—a driver's licenses—which may be supported by point-of-sale sale customer identification system 512. In the embodiment of FIG. 7, point-of-sale customer identification system 512 includes one or more personal identification document template(s) 704. Template(s) 704 generally define the format, layout, syntax, etc. of the content of a particular type of personal identification document 506. In other words, template(s) 704 define rules about the characteristics of personal identification document 506, which are used by point-of-sale customer identification system 512 to interpret the underlying data contained in personal identification document 506. In this manner, a template 704 provides a logical map (arrow 726—FIG. 7) between the physical document (i.e., personal identification document 506) and the data contained in the document.

Referring to FIG. 7, the exemplary driver's license includes various regions in which predefined types of information are located. For instance, the driver's license illustrated in FIG. 7 comprises the following regions containing the corresponding types of information in parentheses: region 702 (image of customer 506); region 704 (driver's license number of customer 506); region 706 (expiration date of license); region 708 (address of customer 506); region 710 (sex of customer 506); region 712 birthdate of customer 506); region 714 (examination date for license); region 716 (height of customer 506); region 718 (weight of customer 506); region 720 (restrictions for license); region 722 (county issuing license); and region 724 (signature of customer 506). In this example, point-of-sale customer identification system 512 comprises at least one template 704 which defines this document layout.

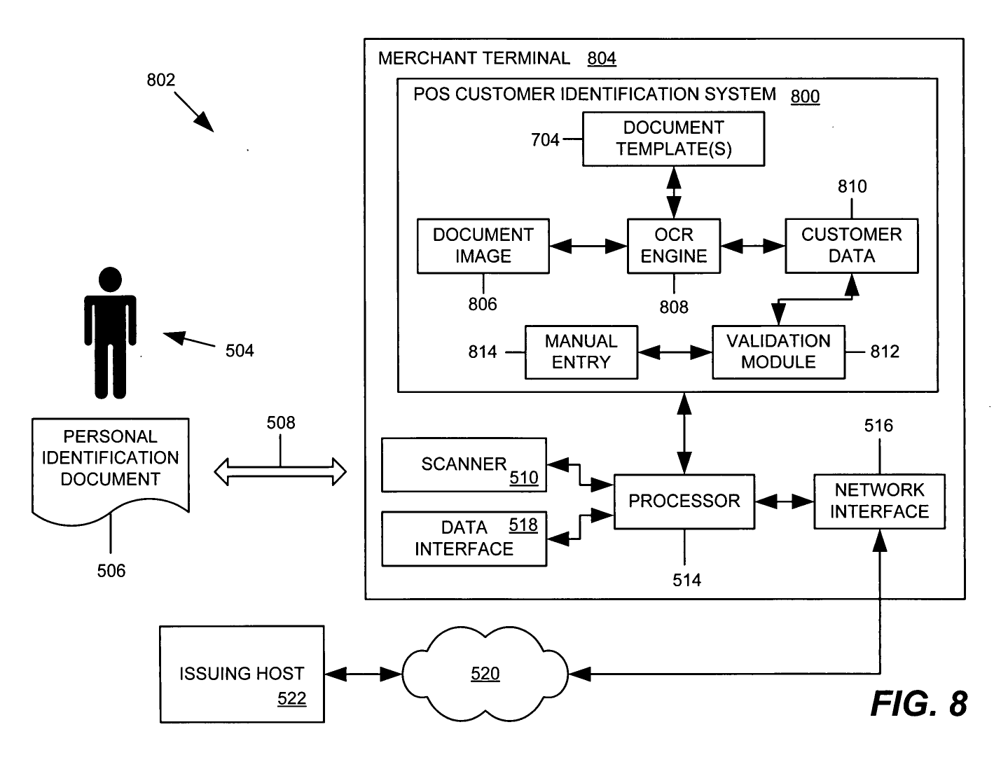

FIG. 8 illustrates another embodiment of a point-of-sale customer identification system 800 in a merchant terminal 804. Similar to merchant terminal 502 (FIG. 5), merchant terminal 804 comprises scanner 510, data interface 518, processor 514, and network interface 516 and communicates with issuing host 522 via communications network 520. In the embodiment illustrated in FIG. 8, point-of-sale customer identification system 800 comprises an optical character recognition (OCR) engine 808, document template(s) 704, a validation module 812, and a manual entry functionality 814.

OCR engine 808 generally comprises logic that accesses a scanned digital image of a personal identification document 506 (i.e., document image 806), recognizes the characters, text, etc. contained in document image 806, and generates a computer-readable version of the data (e.g., customer data 810). OCR engine 808 analyzes document image 806 for light and dark areas in order to identify each alphabetic letter or numeric digit. When a character is recognized, it may be converted into a character code (e.g., ASCII code).

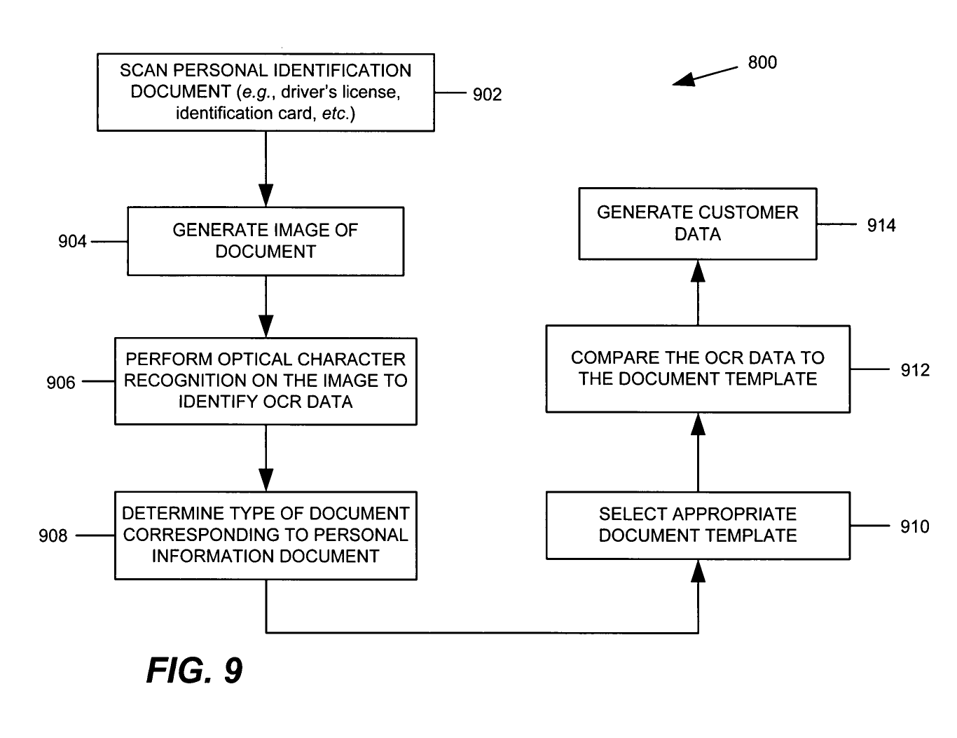

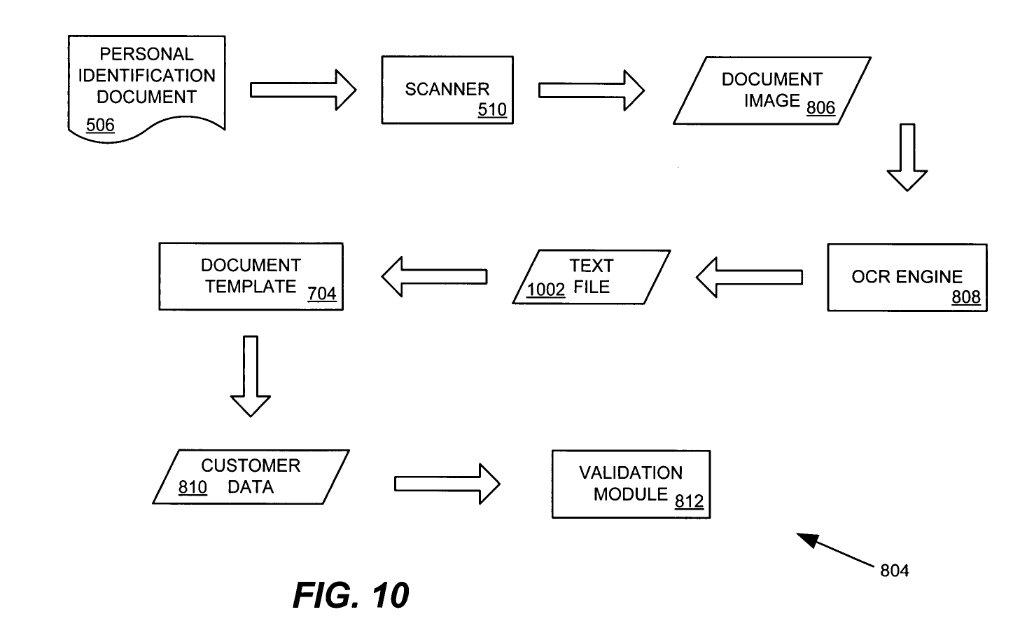

FIG. 9 is a flow chart illustrating the general architecture, operation, and/or functionality of an embodiment of point-of-sale customer identification system 800. At block 902, point-of-sale customer identification system 800 scans a personal identification document 506 corresponding to a customer 504 via scanner 510. At block 904, point-of-sale customer identification system 800 generates a document image 806 (FIG. 8) of personal identification document 506. At block 906, point-of-sale customer identification system 800 performs optical character recognition on document image 806 using OCR engine 808 (FIG. 8). The output of OCR engine 808 may be stored in a computer-readable form, such as a text file 1002 (FIG. 10). At block 908, point-of-sale customer identification system 800 determines the type of document corresponding to personal identification document 506. In one embodiment, point-of-sale customer identification system 800 automatically determines the type of document. In other embodiments, the type of document is provided to point-of-sale customer identification system 800 via, for example, data interface 518 (FIG. 8).

At block 910, point-of-sale customer identification system 800 selects an appropriate document template 704 (FIG. 8) based on the type of document. At block 912, point-of-sale customer identification system 800 compares the computer-readable data from OCR engine 808 (e.g., text file 1002) to the selected document template 704. At block 914, point-of-sale customer identification system 800 generates customer data 810 based on the comparison to the selected template 704.

FIG. 10 is a flow diagram illustrating the basic operation of an embodiment of merchant terminal 804. As illustrated in FIG. 10, scanner 510 scans personal identification document 506 to form a document image 806. Document image 806 is processed by OCR engine 808 and converted into a computer-readable file (e.g., text file 1002). Merchant terminal 804 converts the computer-readable file into customer data 810 by, for example, comparing the computer-readable file to a document template 704 corresponding to the type of personal identification document 506 scanned by merchant terminal 804. As illustrated in FIG. 10, in certain embodiments, customer data 810 may be further processed via validation module 812.

In general, validation module 812 determines whether OCR engine 808 performed any character recognition errors during the character recognition process. For example, OCR engine 808 may improperly recognize one or more characters in document image 806, which may adversely affect the provision of financial services. It should be appreciated that validation module 812 may perform partial, as well as complete, failures of the OCR processing. In other embodiments, validation module 812 may be configured to compare data contained in customer data 810, text file 1002, etc. against predetermined validation criteria to determine whether the customer values for certain data object(s) meet the validation criteria. The validation process may occur locally at merchant terminal 804, at issuing host 522 via communications network 520, at other locations, or via any combination thereof.

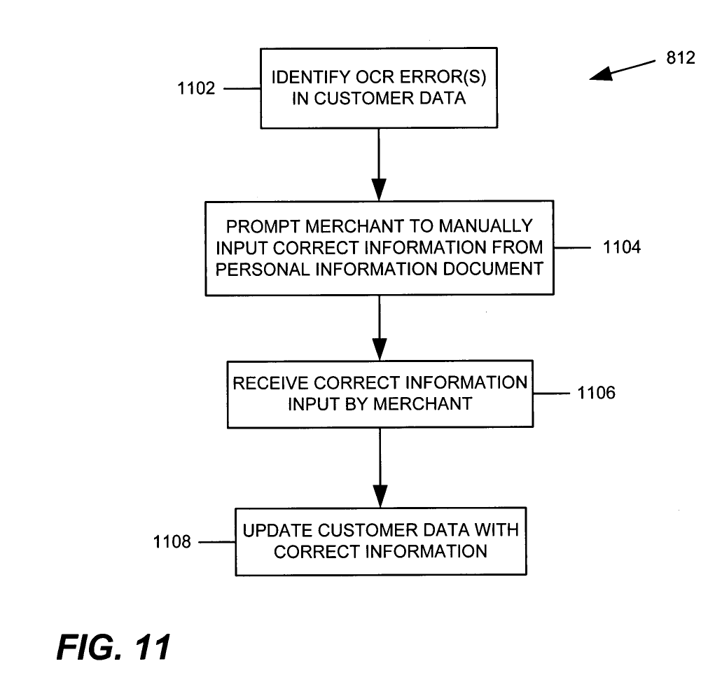

FIG. 11 is a flow chart illustrating the architecture, operation, and/or functionality of an embodiment of validation module 812. At block 1102, validation module 812 identifies one or more OCR errors performed by OCR engine 808. Validation module 812 may identify the OCR error(s) by processing customer data 810 or text file 1002. It should be appreciated that a number of OCR correction mechanisms may be employed to identify the OCR error(s). At block 1104, validation module 812 enables a user (e.g., merchant, customer 504, etc.) to input new customer data to correct the OCR error. Validation module 812 may employ manual entry functionality 814 to prompt the user to manually input correct information directly from personal identification document 506. For example, if validation module 812 identifies an OCR error, a merchant may obtain the physical document and identify the correct information contained on personal identification document 506.

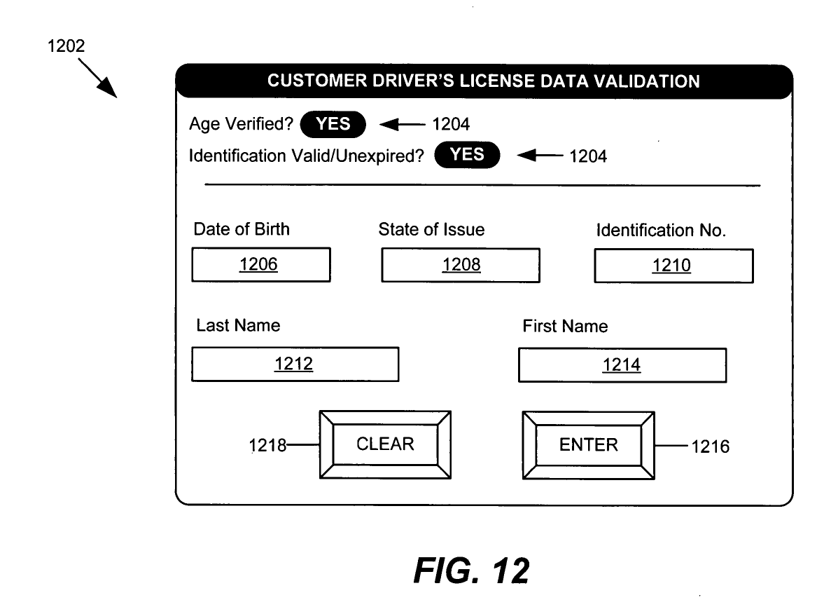

FIG. 12 illustrates an exemplary screen shot of a user interface screen 1202 for enabling the merchant to manually input customer information. In the example of FIG. 12, a driver's license, such as the one illustrated in FIG. 7, has been scanned by merchant terminal 804. As illustrated in FIG. 12, user interface screen 1202 displays verified customer data 1204. It should be appreciated that the customer data may be verified by merchant terminal 804 and/or issuing host 522 using a number of validation criteria. In FIG. 12, verified customer data 1204 comprises birthdate region 712 and expiration date region 706 (FIG. 7). As further illustrated in FIG. 12, user interface screen 1202 also displays various text boxes (1206, 1208, 1210, 1212, and 1214) for manually entering unverified customer data. The unverified customer data may comprise customer data which was not properly recognized by OCR engine 808 or customer data which is not verified based on predefined validation criteria. User interface screen 1202 may also comprise other user interface objects, such as clear button 1218 and enter button 1216.

One of ordinary skill in the art will appreciate that point-of-sale customer identification system 512 and point-of-sale customer identification system 800 may be implemented in software, hardware, firmware, or a combination thereof. Accordingly, in one embodiment, point-of-sale customer identification system 512 and point-of-sale customer identification system 800 are implemented in software or firmware that is stored in a memory and that is executed by a suitable instruction execution system (e.g., processor 514).

In hardware embodiments, point-of-sale customer identification system 512 and point-of-sale customer identification system 800 may be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be further appreciated that the process descriptions or functional blocks related to FIGS. 1-12 represent modules, segments, or portions of logic, code, etc. which include one or more executable instructions for implementing specific logical functions or steps in the process. It should be further appreciated that any logical functions may be executed out of order from that shown or discussed, including substantially concurrently or in reverse order, depending on the functionality involved, as would be understood by those reasonably skilled in the art.

Furthermore, point-of-sale customer identification system 512 and point-of-sale customer identification system 800 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

Although this disclosure describes the invention in terms of exemplary embodiments, the invention is not limited to those embodiments. Rather, a person skilled in the art will construe the appended claims broadly, to include other variants and embodiments of the invention, which those skilled in the art may make or use without departing from the scope and range of equivalents of the invention.

1. A merchant terminal comprising:
a scanner for scanning a personal identification document corresponding to a customer requesting a point-of-sale transaction; and
logic configured to identify customer data from a scanned image of the personal identification document.

2. The merchant terminal of claim 1, further comprising at least one template corresponding to at least one type of personal identification document.

3. The merchant terminal of claim 2, wherein the at least one type of personal identification document comprises one of a driver's license, personal identification card, and a passport.

4. The merchant terminal of claim 1, wherein the scanner comprises a templated scanner configured to automatically determine the type of personal identification document being scanned.

5. The merchant terminal of claim 1, wherein the logic configured to identify customer data from the scanned image comprises software stored in memory and executed by a processor.

6. The merchant terminal of claim 1, wherein the logic configured to identify customer data from the scanned image comprises an optical character recognition (OCR) engine.

7. The merchant terminal of claim 6, wherein the OCR engine is configured to generate a text file containing text from the personal information document.

8. The merchant terminal of claim 7, further comprising logic configured to generate customer data based on a comparison of the text file to a document template corresponding to the personal identification document.

9. The merchant terminal of claim 1, further comprising logic configured to process the point-of-sale transaction using the customer data.

10. The merchant terminal of claim 9, wherein the point-of-sale transaction comprises one of a pre-paid card purchase, a point-of-sale purchase, a pre-paid card acceptance, a credit card acceptance, a debit card acceptance, a card-to-card transaction, and a bill payment.

11. The merchant terminal of claim 1, further comprising logic configured to identify at least one scanning error in the customer data.

12. The merchant terminal of claim 11, wherein the scanning error comprises an optical character recognition error.

13. The merchant terminal of claim 11, further comprising logic configured to enable a user to manually input new customer data to correct the at least one scanning error.

14. The merchant terminal of claim 1, further comprising logic configured to validate the customer data.

15. A method of processing a point-of-sale transaction at a merchant terminal, the method comprising:
scanning a personal identification document corresponding to a customer requesting a financial service at a merchant terminal;
generating a scanned image of the personal identification document;
identifying character data in the scanned image; and
comparing the character data to a document template corresponding to the personal identification document to generate customer data.

16. The method of claim 15, wherein the generating a scanned image comprises performing an optical character recognition algorithm.

17. The method of claim 15, further comprising automatically determining a type of document of which the personal indentification document comprises.

18. The method of claim 17, wherein the automatically determining the type of document comprises comparing the scanned image to a document template.

19. The method of claim 15, wherein the financial service comprises at least one of a pre-paid card purchase, a point-of-sale purchase, a pre-paid card acceptance, a credit card acceptance, a debit card acceptance, a card-to-card transaction, and a bill payment.

20. The method of claim 15, further comprising identifying at least one scanning error and enabling a user to manually input new customer data to correct the at least one scanning error.

21. A method implemented by a merchant terminal, the method comprising:
scanning a personal identification document corresponding to a customer; and
generating customer data from a scanned image of the personal identification document.

22. A financial services system comprising:
a scanner configured to generate a digital image of a customer's personal identification document;
an optical character recognition (OCR) engine for converting the digital image into a text file; and
logic configured to generate customer data associated with the text file by comparing the text file to a document template of the personal identification document.

23. The financial services system of claim 22, further comprising a validation module configured to determine at least one OCR error.

24. The financial services system of claim 23, wherein the validation module is further configured to prompt a user to input new customer data corresponding to the at least one OCR error.

25. A point-of-sale merchant terminal comprising:
means for scanning a customer's personal identification document; and
means for identifying customer data from the scanned image of the personal identification document.

26. The point-of-sale merchant terminal of claim 25, further comprising means for providing a financial service based on the identified customer data.
